(19) United States
(12) Patent Application Publication
(10) Pub. No.: US 2022/0331959 A1
(43) Pub. Date: Oct. 20, 2022

(54) ROBOTIC OPERATING ENVIRONMENT RENDERING

(71) Applicant: Intrinsic Innovation LLC, Mountain View, CA (US)

(72) Inventors: Timothy Robert Kelch, San Jose, CA (US); Shameek Ganguly, Milpitas, CA (US); Aida Zhumabekova, San Jose, CA (US)

(73) Assignee: Intrinsic Innovation LLC, Mountain View, CA (US)

(21) Appl. No.: 17/230,294

(22) Filed: Apr. 14, 2021

(51) Int. Cl. B25J 9/16

(52) U.S. Cl. CPC B25J 9/1671; B25J 9/161; B25J 9/1697; B25J 9/1674

(57) ABSTRACT

In one aspect, there is provided a computer-implemented method that incudes obtaining physical sensor measurements of a physical robotic operating environment and obtaining a virtual representation of the robotic operating environment. The method further includes generating a user interface presentation including a first view of the virtual representation based virtual sensor parameters, and a second view of the physical robotic operating environment based on the physical sensor measurements. The method further includes receiving an update to values of the virtual sensor parameters, and updating, in the user interface presentation, the first view of the virtual representation based on the updated values of the virtual sensor parameters.

### BACKGROUND

This specification relates generally to robotics. More specifically, this specification relates to methods and systems for improving robotic operating environment rendering.

Industrial manufacturing of today heavily relies on robotics for automation. As the complexity of automated manufacturing processes have increased over time, so has the demand for robotic systems capable of high precision and excellent performance. This, in turn, gave way to off-line programming and simulation tools that enable programming robotic systems and simulating their behavior under different scenarios in virtualized operational environment (e.g., a workcell), with a view to improve their performance on the manufacturing floor.

The effectiveness of off-line programming rests on obtaining parity between the virtual representation of the workcell environment and the physical workcell. The better the physical workcell environment is represented in the virtual world, the more effectively it can be calibrated for precise contact operations. An off-line generated robot program that is based on a simulation with maximum correspondence between the virtual and the physical workcell can drive the physical robot with maximum accuracy and precision.

Generally, the process of workcell calibration requires calibrating all components inside the workcell, including various sensors. Sensor calibration is the process of determining intrinsic (e.g., focal length, distortion coefficients) and extrinsic (e.g., position and orientation with respect to the environment) parameters of the sensor.

### SUMMARY

This specification describes a system for improving virtual robotic operating environment rendering.

According to a first aspect, there is provided a method that includes obtaining physical sensor measurements of a physical robotic operating environment having a physical robot. The method further includes obtaining a virtual representation of the robotic operating environment having a virtual robot that represent the physical robot. The method further includes generating a user interface presentation that includes a view of the virtual representation of the robotic operating environment based on virtual sensor parameters and a view of the physical robotic operating environment based on physical sensor measurements. The method further includes receiving an update to values of the virtual sensor parameters and updating, in the user interface presentation, the view of the virtual representation of the robotic operating environment based on the updated values of the virtual sensor parameters.

Particular embodiments of the subject matter described in this specification can be implemented so as to realize one or more of the following advantages.

While many industrial robotic systems have excellent repeatability, the accuracy of movements and operations can suffer significantly due to many potential sources of error. For example, a slight shift away from pre-programmed movement of the robot at an early stage can lead to cumulative increase in errors later in the manufacturing process. Having the ability to fix the error in real-time through virtual representation of the robotic operating environment rendering can significantly improve the accuracy of robotic systems. Accordingly, there exists a growing need for an economical, fast, highly customizable, and efficient method and system for identifying disparities between physical operating robotic environment and virtual rendering of the same.

One way of calibrating the robotic system involves the generation of a “virtual vantage point”—a view of the virtual environment through the perspective of a virtual sensor. The virtual vantage point can be leveraged in conjunction with data acquired by a sensor in the physical environment to manually calibrate the virtual sensor and adjust simulation parameters (e.g., surface friction), thereby attaining parity between the physical world and its virtual counterpart.

By employing the described techniques, a robot system can be provided with accurate representation of the physical operating environment that can then allow it to effectively generate motion plans for controlling the robot system, e.g., by generating initial plan that is based on the sensor observations of the workcell and is optimized, or by generating modified plans to avoid collision of a robot with other physical objects within the workcell that are observed by the sensors.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for improving virtual robotic operating environment rendering.

FIG. 2 is a flow diagram of an example process for improving virtual robotic operating environment rendering.

FIG. 3 illustrates an example user interface presentation.

Like reference numbers and designations in the various drawings indicate like elements.

### DETAILED DESCRIPTION

The systems and methods described in this specification improve virtual robotic operating environment rendering thereby improving the accuracy of robotic motion plans and operation of physical robotic systems. Typically, a physical camera (or other sensors) positioned in the physical robotic environment can provide a view of the environment that can be observed by an operator. The systems and methods described in this specification can simulate a virtual camera (or other sensors) in virtual robotic operating environment that can emulate the view from the perspective of the physical camera. The operator can observe both the physical camera view and the virtual camera view and determine whether any discrepancies exist between the simulated environment and the physical environment. The operator can adjust simulation parameters of the virtual camera so that the view from the virtual camera more closely matches the view from the physical camera. Similarly, the operator can adjust the simulation parameters of virtual objects so that their properties more closely match the corresponding properties of physical objects. Thereby, the systems and methods described in this specification can improve virtual robotic operating environment rendering and ensure parity between the physical environment and the virtual one. Further, the systems and methods described in this specification can adjust the simulation parameters automatically and in real-time, thereby automatically improving virtual robotic operating environment rendering.

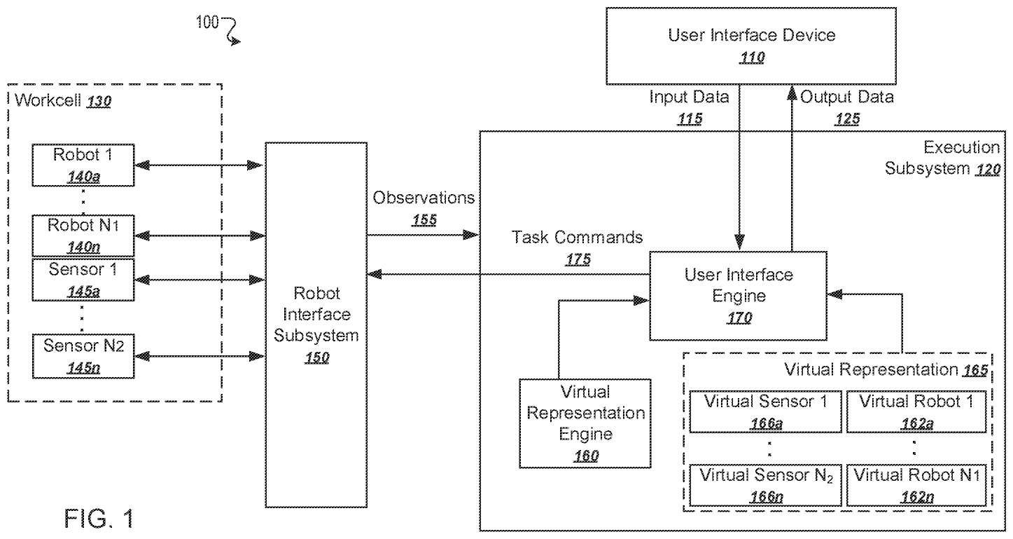

FIG. 1 illustrates an example system 100 for improving virtual robotic operating environment rendering. The system 100 can be implemented as computer programs installed on one or more computers in one or more locations that are coupled to each other through any appropriate communications network, e.g., an intranet or the Internet, or a combination of networks. The system 100 can simulate a virtual representation of the robotic operating environment and detect discrepancies between the physical environment and its virtual counterpart. Further, the system 100 can be used to adjust the virtual environment to more closely match the physical one, thereby improving virtual environment rendering.

The system 100 can include a physical operating environment 130 (e.g., a physical workcell) having one or more devices. The devices can include a physical robot 140a and a corresponding physical sensor 145a, which can be a camera, or any other sensor. The sensor 145a can be mounted on the robot 140a, or it can be positioned anywhere in the workcell 130. The workcell 130 can include multiple devices, such as robots 140 and sensors 145).

The system 100 further includes a robot interface subsystem 150 that acts as an interface between the devices 140, 145 in the workcell 130 and an execution subsystem 120. The robot interface system 150 can receive observations 155 from the devices 140, 145, such as sensor measurements and information about the poses of devices 140, 145 in the workcell 130. The observations 155 can include physical sensor measurements of an object to be manipulated by physical robots 140, e.g., the weight of a box positioned in the workcell 130. In some implementation, a camera in the workcell 130 can acquire visual data and provide observations 155 in the form of visual data to the robot interface subsystem 150.

The execution subsystem 120 can receive the observations 155 from the robot interface subsystem 150 and use them to control the devices 140, 145 in the workcell 130. For example, a user interface engine 170 included in the execution subsystem 120 can process the observations 155 and generate task commands 175 for controlling the robots 140, and output the commands 175 to the robots 140 through the robot interface subsystem 150. Task commands 175 can be programs that instruct the robot 140a in the workcell to perform a task, e.g., to pick up an object in the workcell 130.

In some implementations, the task commands 175 can be provided by a user through a user interface device 110, which can be any appropriate stationary or mobile computing device, such as a desktop computer, a workstation in a robot factory, a tablet, a smartphone, or a smartwatch. For example, a user can interact with the user interface device 110 to generate input data 115 (e.g., instruct a robot 140 to pick up a box in the workcell 130), the user interface engine 170 can process the input data 115 to generate the corresponding task command 175, provide the task command 175 to the robot interface subsystem 150, and trigger the robot 140 to perform the task. Input data 115 can also include any appropriate parameter of the system 100.

The user interface engine 170 can generate output data 125 and provide it to the user interface device 110 that can present the output data 125 in a graphical user interface. For example, the user interface engine 170 can generate output data 125 based on observations 155 received from the devices 140, 145. The user interface device 110 can generate a user interface presentation including a view of the physical robotic operating environment (e.g., the workcell 130) based on physical sensor measurements (e.g., measurements received from a camera 145a in the workcell 130).

The user can view the output data 125 through the user interface device 110 and control the robots 140 in the workcell 130 by providing input data 115. The user interface device 110 can present user interface controls (e.g., toggles) that a user can interact with to provide input data 115. For example, a user can see the view of the workcell 130 in the user interface presentation, acquired from a camera 145a in the workcell 130, and interact with the user interface controls to change, e.g., a position of the robot 140, which can then be received as input data 115 by the user interface engine 170 and trigger the robot 14a0 to change its position in the workcell 130 accordingly.

The execution subsystem 120 can further include a virtual representation engine 160 that communicates with the user interface engine 170 and simulates a virtual representation 165 of the workcell 130 according to simulation parameters. The virtual representation 165 can be a digital model, e.g., a CAD model, and it can include data emulating the workcell 130, e.g., virtual robots 162 emulating physical robots 140, and virtual sensors 166 emulating physical sensors 145. For example, the physical robot 140a in the workcell 130 can include a camera 145aa, and the virtual representation 165 can include a corresponding virtual robot 162 with a corresponding virtual camera 166a.

The user interface device 110 can generate a presentation of the simulated virtual representation 165. For example, the virtual representation engine 160 can provide output data 125 (e.g., the virtual representation 165) to the user interface device 110, and a user can view the virtual representation 165 in the graphical user interface of the user interface device 110. In other words, the user can view virtual robots 162 and virtual sensors 166 in a virtual robotic operating environment that emulates the physical workcell 130.

Further, the user interface device 110 can generate a presentation of the virtual representation 165 of the robotic operating environment from the perspective of a virtual sensor 166 based on virtual sensor parameters. For example, the virtual representation engine 160 can simulate a view from the perspective of a virtual camera 166a that emulates a view from the perspective of the physical camera 145 in the workcell 130, and the virtual sensor parameters can be e.g., brightness of the virtual camera 166a that emulates brightness of the physical camera 145a in the workcell 130. Virtual sensor parameters can represent lighting, color, or texture properties of a virtual object that emulates a physical object in the workcell 130. For example, a virtual sensor parameter can be friction of the material of a virtual object simulated in the virtual representation 165.

The user interface device 110 can generate a presentation that includes a view of the virtual representation 165 of the robotic operating environment 130 based on virtual sensor parameters and a view of the physical robotic operating environment 130 based on physical sensor measurements. For example, the presentation can include both a simulated view from the perspective of the virtual camera 166a and a view from the perspective of the physical camera 130. A user can visually compare both views and determine if there is a “discrepancy” between the physical workcell 130 and its virtual representation 165. For example, the user can determine whether: any devices 162, 166 (or objects) in the virtual representation 165 are missing, any objects in the virtual representation 165 are present that are not present in the physical workcell 130, locations of virtual objects match locations of physical objects, there is any unexpected shadowcasting or obstruction, textures of objects in the virtual representation 165 correctly represent the same in the workcell 130. Based on the determination, the user can interact with the user interface device 110 and adjust or update virtual sensor parameters such that the virtual representation 165 of the workcell 130 more closely matches the physical workcell 130, as will be described in more detail below.

The user interface engine 170 can generate task commands 175 according to the input data 115 received from the user interface device 110 and provide the task commands 175 to the virtual representation engine 160. The virtual representation engine 160 can simulate the virtual devices 162, 165 in the virtual representation 165 to perform the task. For example, a user can interact with the user interface device 110 to instruct a virtual robot 162 in the virtual representation to pick up an object simulated in the virtual representation 165. In response, the virtual representation engine 160 can simulate the virtual robot 162a picking up the object.

A user can interact with the user interface device 110 to update virtual sensor parameters. For example, the user interface device 110 can present a user interface control (e.g., a toggle) and a user can interact with the control to change the value of the virtual sensor parameter (e.g., brightness of the virtual camera 166) from a first value to a second value. The second value can be received as input data 115 by the user interface engine 170 that can provide it to the virtual representation engine 160. In response, the virtual representation engine 160 can alter the simulation of the virtual representation 165 such that the virtual sensor 165 is simulated to reflect the new value of the virtual sensor parameter (e.g., simulate the virtual camera 166 according to the updated value of brightness). Then, the user interface presentation in the user interface device 110 can be updated based on the updated value of the virtual sensor parameter (e.g., the view from the perspective of the virtual camera 166 can be updated in the user interface presentation to reflect the new brightness parameter).

Instead of being updated by a user, the virtual sensor parameters can be updated automatically. As described above, measurements from physical sensors 145 in the workcell 130 can be received by the user interface engine 170 as observations 155. The user interface engine 170 can generate physical sensor parameter values from physical sensor measurements. For example, the physical camera 145 in the workcell 130 can measure brightness, and a corresponding brightness parameter value can be generated by the user interface engine 170. The user interface engine 170 can automatically set the value of the virtual sensor parameter based on the generated physical sensor parameter value. For example, the user interface engine 170 can automatically set the value of brightness of the virtual camera 166a based on the generated value of brightness of the physical camera 145a. The virtual representation engine 160 can simulate the virtual sensor 166 according to the new virtual sensor parameter value. A user can still interact with the use interface device 110 to adjust the automatically set values of virtual sensor parameters in a similar way as described above.

The user interface device 110 can generated a presentation in the graphical user interface that compares the generated physical sensor parameter values with the virtual sensor parameter values. For example, the user interface engine 170 can generate a lighting histogram based on measurements received from the physical camera in the workcell 130 and present it on the user interface device 110. Similarly, the user interface engine 170 can generate a lighting histogram based on virtual parameter values of the virtual camera 166 and present it on the user interface device 110. The lighting histogram of the physical workcell 130 and the lighting histogram of the virtual representation 165 of the workcell 130 can be viewed by a user on the user interface device 110 and visually compared. As described above, the virtual representation engine 160 can simulate the operation of virtual robots 162 and sensors 165 in the virtual representation 165 of the physical workcell 130. For example, a user can provide task commands 175 to trigger the virtual robot 166 to perform the task (e.g., pick up an object in the virtual representation 165 of the physical workcell 130). The virtual representation engine 160 can simulate the robot 166 performing the task, and the virtual implementation of the task can be viewed by a user on the user interface device 110.

After the virtual sensor parameters have been updated, either manually by a user, automatically, or both, the virtual representation engine 160 can simulate the virtual robots 162 performing the task using the updated sensor parameters. For example, the friction parameter of the virtual box can be updated, and virtual representation engine 160 can simulate the virtual robot 162 picking up the virtual box using the updated friction parameter. The user interface engine 170 can determine whether the simulation task succeeded (e.g., whether the virtual robot 162 successfully picked up the box) by computing a performance measure for the task, which can then be presented in the graphical user interface of the user interface device 110. Further, a prompt to perform the task in the physical workcell 130 can be generated by the user interface engine 170 and presented on the user interface device 110 (e.g., a window with text asking if the task should be performed, and “yes”/“no” buttons). A user can interact with the user interface device 110 by e.g., clicking on the “yes” button, which can be received as input data 115 by the user interface engine 170. In response, the user interface engine 170 can generate task commands 175, send the commands 175 to the physical robot 140a via the robot interface subsystem 150, and drive the robot 140a to perform the task in the workcell 130 (e.g., to pick up a physical object in the workcell 130). F

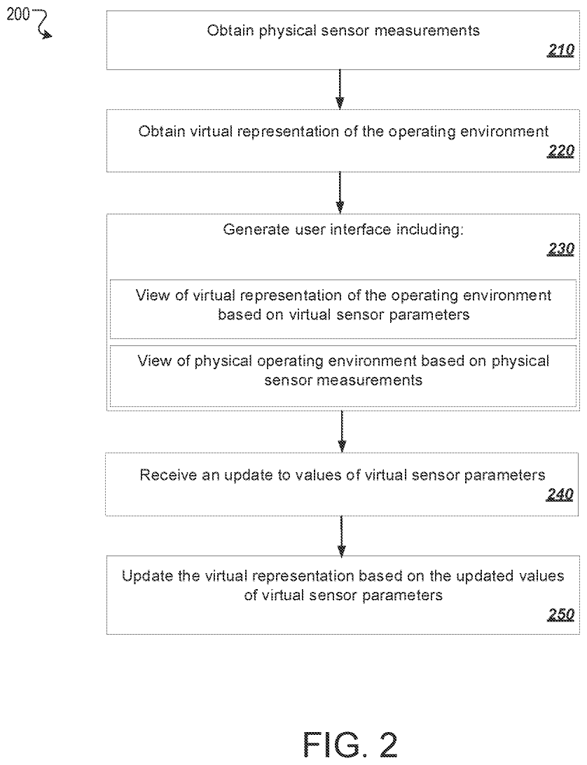

FIG. 2 is a flow diagram of an example process 200 for improving virtual robotic operating environment rendering. For convenience, the process 200 will be described as being performed by a system of one or more computers located in one or more locations. For example, a system for improving virtual robotic operating environment rendering, e.g., the system 100 of FIG. 1, appropriately programmed, can perform the process 200.

The system obtains one or more physical sensor measurements of a physical robotic operating environment having one or more physical robots (210). As described above, the physical robotic operating environment can be a workcell, which can include robots and corresponding physical sensors (e.g., cameras, or any other sensors). Physical sensor measurements can include measurements of an object to be manipulated by physical robots. For example, the measurement can be the weight of a box to be picked up by a robot, or friction of the material of the box. In another example, physical sensor measurements can include visual data obtained from a physical camera in the workcell.

The system obtains a virtual representation of the robotic operating environment (220). As described above, a virtual representation engine can generate one or more virtual representations of physical devices in the workcell, e.g., generate a virtual robot and a virtual sensor in a virtual representation of the robotic operating environment that emulate a physical robot and a physical sensor in the workcell, respectively. The virtual representation can be a virtual copy of the workcell such as, e.g., a digital CAD model.

The system generates a user interface presentation (230). The presentation can be generated on a user interface device, e.g., a computer screen. The user interface presentation can include a view of the physical robotic operating environment based on the physical sensor measurements. For example, the view can include a view from the perspective of a physical camera in the workcell, and physical sensor measurements can include visual data generated by the physical camera. The view can be a window in the user interface presentation that presents visual data obtained from the physical camera.

The user interface presentation can also include a view of the virtual representation of the robotic operating environment based on one or more virtual sensor parameters. For example, the view can include a view from the perspective of a virtual camera, and virtual sensor parameters can include simulation parameters of the virtual camera that correspond to physical parameters of the physical camera (e.g., a simulated brightness parameter of the virtual camera that emulates the brightness of the physical camera). The view can be a window in the user interface presentation that presents simulation data. The view of the physical robotic operating environment and the view of the virtual representation of the robotic operating environment can be presented in the user interface presentation side-by-side. Virtual sensor parameters can represent, for example, lighting, color, and texture properties of a virtual object that emulate the physical properties of a physical object in the workcell.

The system receives an update to values of the one or more virtual sensor parameters (240). For example, one or more virtual sensor parameters can be adjusted in the simulation such that the view of the virtual robotic operating environment matches more closely the view of the physical robotic operating environment. For example, the virtual parameter corresponding to brightness can be adjusted such that the brightness in the virtual camera view of the virtual representation more closely matches the brightness in the physical camera view in the workcell. Similarly, virtual sensor parameters representing lighting, color, and texture properties of a virtual object can be adjusted to more closely match lighting, color, and texture properties of the corresponding physical object in the workcell.

A user can update the values of virtual sensor parameters manually. Updating the values of the virtual sensor parameters can include presenting, within the user interface presentation, one or more user interface controls for the one or more virtual sensor parameters, and receiving user input corresponding to user interaction with the one or more user interface controls. The user input can represent the update to the values of one or more virtual sensor parameters. The user interface control can be a visual element (e.g., a radio button or a toggle) that a user can interact with to change a value of the corresponding virtual sensor parameter. For example, a user interface control corresponding to brightness of a virtual camera can be presented on a computer screen, the user can interact with the control to change the value of brightness of the virtual camera from a first value to a second value in the simulation, and the second value can then be received by the system as user input.

The system updates, in the user interface presentation, the view of the virtual representation of the robotic operating environment based on the updated values of the one or more virtual sensor parameters (250). For example, the brightness in the virtual camera view can change corresponding to the second value received as user input by the system in the simulation.

Alternatively, the values of virtual sensor parameters can be updated automatically based on physical sensor measurements. This can include generating, from the one or more physical sensor measurements, one or more respective physical sensor parameter values for each of the one or more virtual sensor parameters, and automatically setting values of the one or more virtual sensor parameters based on the generated one or more physical sensor parameter values. For example, a physical sensor measurement can include a measurement of brightness generated by the physical camera in the workcell, and a corresponding virtual sensor parameter can include brightness of the virtual camera. The value of brightness of the virtual camera can be automatically set to match the value of brightness measured by the physical camera. In this way, the system can automatically set the values of virtual sensor parameters to match the values of physical sensor parameters corresponding to measurements from physical sensors in the workcell. Thereby, the system can automatically improve virtual robotic environment rendering such that it more closely matches the physical workcell. However, the user can still manually adjust the automatically set values of the one or more sensor parameters in a similar way as described above.

The system can compare the physical sensor parameter values and the virtual sensor parameter values (e.g., brightness value generated based on measurements of the physical camera and brightness value of the virtual camera, respectively). The system can generate, from the one or more physical sensor measurements, one or more respective physical sensor parameter values for each of the one or more virtual sensor parameters. For example, as described above, a physical sensor measurement can include a measurement of lighting in the workcell generated by the physical camera, and a corresponding virtual sensor parameter can include lighting of the virtual camera. The system can present, within the user interface presentation, a visual representation that compares the one or more generated physical sensor parameter values with the one or more virtual sensor parameter values. For example, based on the measurements generated by the physical camera, the system can generate a lighting histogram that represents lighting in the workcell. Similarly, based on the virtual parameter values of the virtual camera, the system can generate a lighting histogram that represents lighting in the virtual representation of the workcell. The system can present the histograms on the user interface device to facilitate a comparison of lighting in the physical environment with that in the virtual environment.

After updating the view of the virtual representation of the robotic operating environment, the system can perform, within the virtual representation, a simulation of a task performed by the one or more robots using the updated values of the one or more virtual sensor parameters. For example, the updated virtual sensor parameter can include an updated value of friction of a material of a virtual object, e.g., a box, and the system can instruct a virtual robot to pick up the box within the virtual representation. The system can simulate the virtual robot picking up the box. If the task succeeded, e.g., the robot successfully picked up the box, the system can present, within the user interface presentation, an indication that the simulation of the task succeeded and a prompt to perform the task in the physical operating environment. A user can interact with the prompt by, for example, interacting with a user interface control that corresponds to triggering the task. In response to receiving user interaction with the prompt, the system can drive the one or more physical robots in the workcell to perform the task in the physical operating environment.

Accordingly, because the virtual environment is tuned to more accurately represent the physical operating environment, the simulation of the task, in turn, more accurately represents the task to be performed by physical robots in the workcell, which increases the precision of contact operations and improves the safety and efficiency of the physical robotic system when it performs the task. By adjusting the simulation parameters (e.g., the virtual sensor parameters) an operator is able to fine-tune the program before providing it to the physical system, so that it can enhance the system's performance on the manufacturing floor and reduce the likelihood of accidents and misalignments. Furthermore, the virtual operating environment rendering can be improved automatically and in real-time, thereby automatically improving the accuracy and precision of robotic systems.

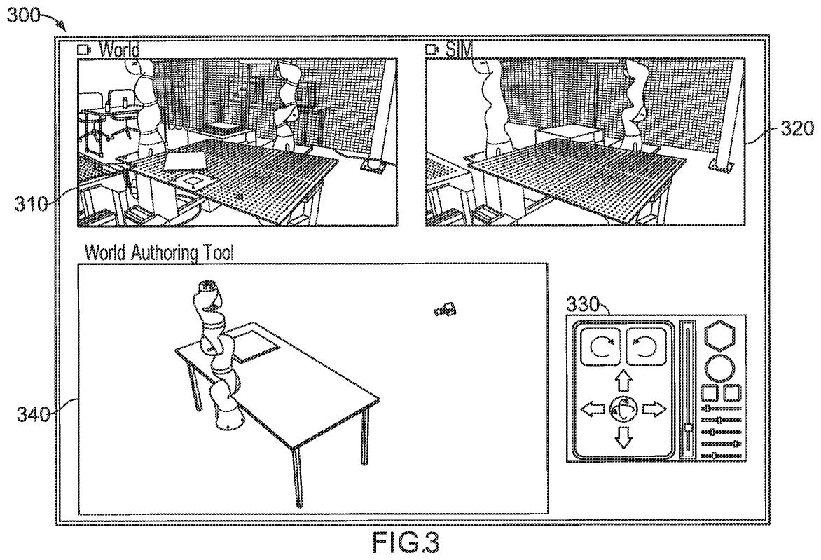

FIG. 3 illustrates an example user interface presentation 300 that can be generated on a user interface device 110 as described above with reference to FIGS. 1 and 2. The user interface presentation 300 can include a view of a physical robotic operating environment 310 (e.g., a workcell) containing robots and sensors. The view can be based on physical sensor measurements generated by sensors located in the workcell (e.g., visual data obtained from a camera positioned in the workcell).

The user interface presentation 300 can also include a view of the virtual representation of the robotic operating environment 320 (e.g., a virtual workcell) containing simulated virtual robots and virtual sensors. The view 320 can be based on virtual sensor parameters that can be simulation parameters 330 that generate the simulation of the virtual camera view 320. The simulation parameters 330 can be presented as user-modifiable user interface elements (e.g., toggles) in the user interface presentation 300. An operator can observe the virtual view 320 and the physical view 310 side-by-side and determine if any discrepancies exist between the virtual view 320 and the physical view 310. The operator can accordingly adjust the simulation parameters 330 so that the simulated virtual view 320 more closely matches the physical view 310 (e.g., adjust simulation parameters corresponding to lighting, colors, textures, etc., of objects in the virtual view so that they more closely match the physical properties of objects in the physical view). For example, as described above, the operator can interact with the user interface element to change the value of one or more virtual sensor parameters (e.g., simulation parameters). The simulation parameters can also be adjusted in any other suitable way, such as, e.g., through the command line presented on the user interface device, an Application Programming Interface (API), historical usage of the same or similar object, or by uploading a configuration file that specifies simulation parameter values. The simulation parameters can also be adjusted automatically based on measurements received from physical sensors in the workcell.

The user interface presentation 300 can also include virtual representation 340 of the physical robotic operating environment. As described above, the virtual representation 340 can be a digital model, e.g., a CAD model that emulates the physical environment. The systems described in this specification can simulate the robots in the virtual representation 340 to perform a task (e.g., pick up an object), determine whether the task has been performed successfully, and if so, trigger the physical robot in the physical environment to perform the task.

An operator can compare the physical view 310 and the virtual view 320 and determine if any discrepancies exists between them. An operator can adjust the simulation parameters 330 so that objects in the simulated camera view 320 correctly represent physical objects in the physical camera view 320. After updating the simulation parameters 330, the robots in the virtual representation 340 of the physical robotic operating environment can be simulated to perform a task. If the task has been performed successfully, the physical robots in the workcell can be driven to perform the task.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
obtaining one or more physical sensor measurements of a physical robotic operating environment having one or more physical robots;
obtaining a virtual representation of the robotic operating environment, the virtual representation having one or more virtual robots that represent the one or more physical robots;
generating a user interface presentation comprising:
   a first view of the virtual representation of the robotic operating environment based on one or more virtual sensor parameters, and
   a second view of the physical robotic operating environment based on the one or more physical sensor measurements;
receiving an update to values of the one or more virtual sensor parameters;
updating, in the user interface presentation, the first view of the virtual representation of the robotic operating environment based on the updated values of the one or more virtual sensor parameters; and
performing, within the virtual representation, a simulation of a task being performed by the one or more robots using the updated values of the one or more virtual sensor parameters.

Embodiment 2 is a method embodiment 1, wherein receiving the update to the values of the one or more virtual sensor parameters comprises:
presenting, within the user interface presentation, one or more user interface controls for the one or more virtual sensor parameters; and
receiving user input corresponding to user interaction with the one or more user interface controls, the user input representing the update to the values of one or more virtual sensor parameters.

Embodiment 3 is the method of any one of embodiments 1-2, further comprising:
generating, from the one or more physical sensor measurements, one or more respective physical sensor parameter values for each of the one or more virtual sensor parameters; and
presenting, within the user interface presentation, a visual representation that compares the one or more generated physical sensor parameter values with the one or more virtual sensor parameter values.

Embodiment 4 is the method of any one of embodiments 1-3, wherein receiving the update to the one or more virtual sensor parameters comprises:
generating, from the one or more physical sensor measurements, one or more respective physical sensor parameter values for each of the one or more virtual sensor parameters; and
automatically setting values of the one or more virtual sensor parameters based on the generated one or more physical sensor parameter values.

Embodiment 5 is the method of embodiment 4, further comprising:
presenting, within the user interface presentation, one or more user interface controls for the one or more virtual sensor parameters;
receiving user input corresponding to user interaction with the one or more user interface controls, the user input representing the updated to the values of one or more virtual sensor parameters; and
adjusting the automatically set values of the one or more virtual sensor parameters based on the user input.

Embodiment 6 is the method of any one of embodiments 1-5, further comprising:
determining that the simulation of the task succeeded using the updated values of the one or more virtual sensor parameters;
presenting, within the user interface presentation, an indication that the simulation of the task succeeded and a prompt to perform the task in the physical operating environment; and
in response to receiving user interaction with the prompt, driving the one or more physical robots in a workcell to perform the task in the physical operating environment.

Embodiment 7 is the method of any one of embodiments 1-6, wherein obtaining the one or more physical sensor measurements of a physical robotic operating environment comprises obtaining physical sensor measurements of an object to be manipulated by the one or more physical robots.

Embodiment 8 is the method of any one of embodiments 1-7, wherein the one or more virtual sensor parameters represent lighting, color, or texture properties of the object.

Embodiment 9 is the method of any one of embodiments 1-8, wherein the virtual representation comprises one or more physical parameters of the object, and further comprising:
simulating operation of the one or more robots using the one or more physical parameters of the object.

Embodiment 10 is a system comprising one or more computers, and one or more storage devices communicatively coupled to the one or more computers, wherein the one or more storage devices store instructions that, when executed by the one or more computers, cause the one or more computers to perform the method of any one of embodiments 1 to 9.

Embodiment 11 is one or more non-transitory computer storage media storing instructions that, when executed by one or more computers, cause the one or more computers to perform the method of any one of embodiments 1 to 9.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
obtaining one or more physical sensor measurements of a physical robotic operating environment having one or more physical robots;
obtaining a virtual representation of the robotic operating environment, the virtual representation having one or more virtual robots that represent the one or more physical robots;
generating a user interface presentation comprising:
a first view of the virtual representation of the robotic operating environment based on one or more virtual sensor parameters, and
a second view of the physical robotic operating environment based on the one or more physical sensor measurements;
receiving an update to values of the one or more virtual sensor parameters;
updating, in the user interface presentation, the first view of the virtual representation of the robotic operating environment based on the updated values of the one or more virtual sensor parameters; and
performing, within the virtual representation, a simulation of a task being performed by the one or more robots using the updated values of the one or more virtual sensor parameters.

2. The method of claim 1, wherein receiving the update to the values of the one or more virtual sensor parameters comprises:
presenting, within the user interface presentation, one or more user interface controls for the one or more virtual sensor parameters; and
receiving user input corresponding to user interaction with the one or more user interface controls, the user input representing the update to the values of one or more virtual sensor parameters.

3. The method of claim 1, further comprising:
generating, from the one or more physical sensor measurements, one or more respective physical sensor parameter values for each of the one or more virtual sensor parameters; and
presenting, within the user interface presentation, a visual representation that compares the one or more generated physical sensor parameter values with the one or more virtual sensor parameter values.

4. The method of claim 1, wherein receiving the update to the one or more virtual sensor parameters comprises:
generating, from the one or more physical sensor measurements, one or more respective physical sensor parameter values for each of the one or more virtual sensor parameters; and
automatically setting values of the one or more virtual sensor parameters based on the generated one or more physical sensor parameter values.

5. The method of claim 4, further comprising:
presenting, within the user interface presentation, one or more user interface controls for the one or more virtual sensor parameters;
receiving user input corresponding to user interaction with the one or more user interface controls, the user input representing the updated to the values of one or more virtual sensor parameters; and
adjusting the automatically set values of the one or more virtual sensor parameters based on the user input.

6. The method of claim 1, further comprising:
determining that the simulation of the task succeeded using the updated values of the one or more virtual sensor parameters;
presenting, within the user interface presentation, an indication that the simulation of the task succeeded and a prompt to perform the task in the physical operating environment; and
in response to receiving user interaction with the prompt, driving the one or more physical robots in a workcell to perform the task in the physical operating environment.

7. The method of claim 1, wherein obtaining the one or more physical sensor measurements of a physical robotic operating environment comprises obtaining physical sensor measurements of an object to be manipulated by the one or more physical robots.

8. The method of claim 7, wherein the one or more virtual sensor parameters represent lighting, color, or texture properties of the object.

9. The method of claim 7, wherein the virtual representation comprises one or more physical parameters of the object, and further comprising:
simulating operation of the one or more robots using the one or more physical parameters of the object.

10. A system comprising one or more computers, and one or more storage devices communicatively coupled to the one or more computers, wherein the one or more storage devices store instructions that, when executed by the one or more computers, cause the one or more computers to perform operations comprising:
obtaining one or more physical sensor measurements of a physical robotic operating environment having one or more physical robots;
obtaining a virtual representation of the robotic operating environment, the virtual representation having one or more virtual robots that represent the one or more physical robots;
generating a user interface presentation comprising
a first view of the virtual representation of the robotic operating environment based on one or more virtual sensor parameters, and
a second view of the physical robotic operating environment based on the one or more physical sensor measurements;
receiving an update to values of the one or more virtual sensor parameters;
updating, in the user interface presentation, the first view of the virtual representation of the robotic operating environment based on the updated values of the one or more virtual sensor parameters; and
performing, within the virtual representation, a simulation of a task being performed by the one or more robots using the updated values of the one or more virtual sensor parameters.

11. The system of claim 10, wherein receiving the update to the values of the one or more virtual sensor parameters comprises:
presenting, within the user interface presentation, one or more user interface controls for the one or more virtual sensor parameters; and
receiving user input corresponding to user interaction with the one or more user interface controls, the user input representing the update to the values of one or more virtual sensor parameters.

12. The system of claim 10, further comprising:
generating, from the one or more physical sensor measurements, one or more respective physical sensor parameter values for each of the one or more virtual sensor parameters; and
presenting, within the user interface presentation, a visual representation that compares the one or more generated physical sensor parameter values with the one or more virtual sensor parameter values.

13. The system of claim 10, wherein receiving the update to the one or more virtual sensor parameters comprises:
generating, from the one or more physical sensor measurements, one or more respective physical sensor parameter values for each of the one or more virtual sensor parameters; and
automatically setting values of the one or more virtual sensor parameters based on the generated one or more physical sensor parameter values.

14. The system of claim 13, further comprising:
presenting, within the user interface presentation, one or more user interface controls for the one or more virtual sensor parameters;
receiving user input corresponding to user interaction with the one or more user interface controls, the user input representing the updated to the values of one or more virtual sensor parameters; and
adjusting the automatically set values of the one or more virtual sensor parameters based on the user input.

15. The system of claim 10, further comprising:
determining that the simulation of the task succeeded using the updated values of the one or more virtual sensor parameters;
presenting, within the user interface presentation, an indication that the simulation of the task succeeded and a prompt to perform the task in the physical operating environment; and
in response to receiving user interaction with the prompt, driving the one or more physical robots in a workcell to perform the task in the physical operating environment.

16. One or more non-transitory computer storage media storing instructions that, when executed by one or more computers, cause the one or more computers to perform operations comprising:
obtaining one or more physical sensor measurements of a physical robotic operating environment having one or more physical robots;
obtaining a virtual representation of the robotic operating environment, the virtual representation having one or more virtual robots that represent the one or more physical robots;
generating a user interface presentation comprising
a first view of the virtual representation of the robotic operating environment based on one or more virtual sensor parameters, and
a second view of the physical robotic operating environment based on the one or more physical sensor measurements;
receiving an update to values of the one or more virtual sensor parameters;
updating, in the user interface presentation, the first view of the virtual representation of the robotic operating environment based on the updated values of the one or more virtual sensor parameters; and
performing, within the virtual representation, a simulation of a task being performed by the one or more robots using the updated values of the one or more virtual sensor parameters.

17. The non-transitory computer storage media of claim 16, wherein receiving the update to the values of the one or more virtual sensor parameters comprises:
presenting, within the user interface presentation, one or more user interface controls for the one or more virtual sensor parameters; and
receiving user input corresponding to user interaction with the one or more user interface controls, the user input representing the update to the values of one or more virtual sensor parameters.

18. The non-transitory computer storage media of claim 16, further comprising:
generating, from the one or more physical sensor measurements, one or more respective physical sensor parameter values for each of the one or more virtual sensor parameters; and
presenting, within the user interface presentation, a visual representation that compares the one or more generated physical sensor parameter values with the one or more virtual sensor parameter values.

19. The non-transitory computer storage media of claim 16, wherein receiving the update to the one or more virtual sensor parameters comprises:
generating, from the one or more physical sensor measurements, one or more respective physical sensor parameter values for each of the one or more virtual sensor parameters; and
automatically setting values of the one or more virtual sensor parameters based on the generated one or more physical sensor parameter values.

20. The non-transitory computer storage media of claim 19, further comprising:
presenting, within the user interface presentation, one or more user interface controls for the one or more virtual sensor parameters;
receiving user input corresponding to user interaction with the one or more user interface controls, the user input representing the updated to the values of one or more virtual sensor parameters; and
adjusting the automatically set values of the one or more virtual sensor parameters based on the user input.
